(19) United States
(12) Patent Application Publication
(10) Pub. No.: US 2016/0152505 A1
(43) Pub. Date: Jun. 2, 2016

(54) Photosensitive Glass Molding and Method of Manufacturing the Same

(71) Applicant: HOYA CORPORATION, Tokyo (JP)

(72) Inventor: Takashi FUSHIE, Tokyo (JP)

(73) Assignee: HOYA CORPORATION, Tokyo (JP)

(21) Appl. No.: 14/906,916

(22) PCT Filed: Aug. 4, 2014
(86) PCT No.: PCT/JP2014/070448

§ 371 Date: Jan. 22, 2016

(30) Foreign Application Priority Data
Aug. 7, 2013 (JP) 2013-164323

(51) Int. Cl. C03B 32/02; C03B 23/00

(52) U.S. Cl. CPC C03B 32/02; C03B 23/0013

(57) ABSTRACT

There is provided a method of manufacturing a photosensitive glass molding, including: softening a solid-state photosensitive glass material by heating; and molding the softened photosensitive glass material to obtain a photosensitive glass molding, wherein in the heating, a crystal precipitated on the photosensitive glass material is melted by heating.

### TECHNICAL FIELD

The present invention relates to a photosensitive glass molding and a method of manufacturing the same.

### DESCRIPTION OF RELATED ART

A photosensitive glass is the glass in which only an exposed portion is crystallized by exposing and applying heat treatment to the glass containing a photosensitive component and a sensitizing component. In the crystallized portion, a solving rate to acid is very fast, compared with a non-crystallized portion. Accordingly, by utilizing such a property, selective etching can be applied to the photosensitive glass. As a result, fine processing can be applied to the photosensitive glass inexpensively, without using the mechanical processing. Further, by applying the heat treatment to the photosensitive glass at a higher temperature than the heat treatment temperature during exposure, it is possible to obtain a crystallized photosensitive glass in which a fine crystal is precipitated in the photosensitive glass. Such a crystallized photosensitive glass is excellent in a mechanical performance.

The photosensitive glass containing the crystallized photosensitive glass can be subjected to a fine processing while having a property specific to a glass, and therefore is applied to an interposer for electrically connecting a semiconductor device, etc., and a wiring board, a substrate for IPD (Integrated Passive Device), and a gas electron amplifying substrate, etc.

The photosensitive glass used for such an application, is normally used by being molded into a plate shape having a prescribed shape.

When the plate-like glass is obtained, a glass material is cutout in a plate-like shape from a rod-like ingot glass. However, when a larger size than a size that can be cutout from the ingot glass is requested, the glass material cutout from the ingot glass is required to be stretched in a radial direction to obtain a desired size.

As a molding method of stretching the glass material having a prescribed shape (for example, a block shape) in the radial direction to obtain a plate-like glass, Reheat-Press is known. In the Reheat-Press, the block-shaped glass material is gradually heated up to a vicinity of a sag temperature (Ts), and a softened glass material is press-molded, to thereby stretch (expand) it in the radial direction while thinning the thickness of the glass material.

A molding condition for the Reheat-Press is required to be determined in consideration of the property of the glass to be molded. For example, patent document 1 teaches as follows: in order to prevent a phenomenon (devitrification) in which a transparency of a glass is lost due to a crystallization of the glass, the glass material is pressed at a lower temperature than a temperature of crystallizing the glass. Thus, the property of the glass is affected by the glass crystallization that occurs by heating. Therefore, patent document 2 teaches as follows: in the heat treatment performed after molding the glass, the temperature of crystallizing the glass and a liquid phase temperature, etc., are controlled to prevent the crystallization of the glass.

### PRIOR ART DOCUMENT

### Patent Document

Patent document 1: Japanese Patent Laid Open Publication No. 2011-57483
Patent document 2: Japanese Patent Laid Open Publication No. 2012-208527

### SUMMARY OF THE INVENTION

### Problem to be Solved by the Invention

Regarding the photosensitive glass as well, a size larger than a size that can be cutout from an ingot glass, is requested in the abovementioned application, as a substrate size becomes larger. Therefore, there is a request that the photosensitive glass material cutout from the ingot glass, is stretched (expanded), to obtain a plate-like glass having a desired large size.

Therefore, the inventors of the present invention apply the Reheat-Press to a block-shaped photosensitive glass material. However, crystals are precipitated in the photosensitive glass by heating, and the photosensitive glass becomes opaque. When the photosensitive glass is exposed and etched in an opaque state to perform fine processing such as formation of through holes, there is a problem that an opaque portion is also etched. Originally, the photosensitive glass is irradiated with UV-rays, to apply selective etching to an irradiated portion only. However, since such an opacity occurs on the entire body of the photosensitive glass, an unexposed portion is also etched.

In the Reheat-Press, molding is performed at the vicinity of a sag temperature point, and therefore the glass is not sufficiently softened, and there is a limit in molding a plate-like glass having a large size (for example, about φ300 mm). Particularly, the photosensitive glass is the glass that is hardly press-molded, and in addition, if the crystallization is advanced, the photosensitive glass is further hardly deformed. Accordingly, there is a problem that the photosensitive glass material cannot be stretched up to a desired size, even if it is press-molded.

Further, when the crystal precipitated during heating in the Reheat-Press, has the same composition as the crystal precipitated by exposure, as shown in FIG. 1, crystals 11 are present in a photosensitive glass substrate 10 (FIG. 1(a)) before the fine processing. When the substrate 10 is covered with a mask 50, and exposed by UV-rays 60 to perform the fine processing such as formation of the through holes (FIG. 1(b)), crystallized portions 12 are formed by heating performed thereafter (FIG. 1(c)). When such crystallized portions 12 are removed by etching, the crystals 11 precipitated during heating, are also removed by etching. Then, not only the through holes 13, but also depressions 14 are formed by solving the crystals 11 (FIG. 1(d)), and there is a problem that a quality product of the photosensitive glass substrate 10 cannot be obtained.

In view of the above-described circumstance, the present invention is provided, and an object of the present invention is to provide a method of obtaining a plate-like glass molding, and the plate-like glass molding having a desired size, by expanding a photosensitive glass material while maintaining an advantage of a photosensitive glass such that fine processing of solving only a prescribed portion of the photosensitive glass can be performed without performing a mechanical processing.

### Means for Solving the Problem

It is found by the inventors of the present invention, that it is difficult to perform press-molding of expanding a glass material up to a desired size, while preventing a precipitation of a crystal during heating, because an overlapped range of a temperature range in which crystallization occurs, and a temperature range in which press molding can be performed, is wide. Therefore, it is also found by the inventors of the present invention, that the above-descried problem can be solved by molding the precipitated crystal after melting the crystal, by keeping a temperature at not less than a liquid phase temperature of the photosensitive glass. Thus, the present invention is completed.

That is, according to an aspect of the present invention, there is provided a method of manufacturing a photosensitive glass molding, including:

softening a solid-state photosensitive glass material by heating; and

molding the softened photosensitive glass material to obtain a photosensitive glass molding,

wherein in the heating, a crystal precipitated on the photosensitive glass material by heating, is melted.

In the above aspect, preferably in the heating, the photosensitive glass material is heated up to not less than a liquid phase temperature of a photosensitive glass, and by holding the photosensitive glass material at this temperature, the crystal is melted, and more preferably a holding time of the photosensitive glass at the temperature not less than the liquid phase temperature of the photosensitive glass, is determined according to a heat capacity.

In the above aspect, preferably a heating rate in a crystallization temperature range of the photosensitive glass is 200° C./min or more in the heating.

In the above aspect, preferably the method further includes cooling the photosensitive glass material after melting the crystal, and a cooling rate in the crystallization temperature range of the photosensitive glass is 200° C./min or more in the cooling.

In the above aspect, preferably the method further includes removing a distortion accumulated in the photosensitive glass molding.

In the above aspect, preferably the photosensitive glass is heated in the heating, using a holding member for holding the photosensitive glass material.

According to another aspect of the present invention, there is provided a photosensitive glass molding manufactured by the method of manufacturing a photosensitive glass molding of any one of the above aspects.

### Advantage of the Invention

According to the present invention, there is provided a method of obtaining a plate-like glass molding, and the plate-like glass molding having a desired size, by expanding a photosensitive glass material while maintaining an advantage of a photosensitive glass such that fine processing of solving only a prescribed portion of the photosensitive glass can be performed without performing a mechanical processing.

### BRIEF DESCRIPTION OF THE DRAWINGS

FIG. 1 is a view showing a state in which a depression is formed on a photosensitive glass by solving a crystal by etching, the crystal being precipitated during heating by a Reheat-Press.

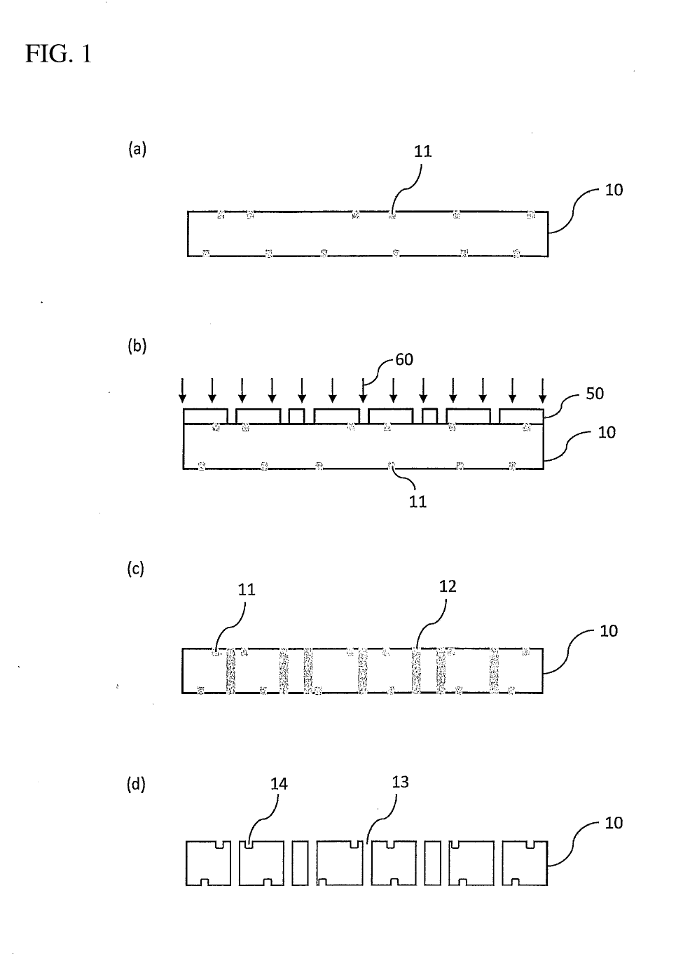

FIG. 2 is a view showing a schematic profile of a surface temperature of a photosensitive glass material in a method of this embodiment.

FIG. 3 is a view showing a photosensitive glass material held by a holding member, in heating.

### DETAILED DESCRIPTION OF THE INVENTION

The present invention will be described hereafter in the following order, based on an embodiment shown in the figure.

1. Photosensitive glass
2. Method of manufacturing a photosensitive glass molding
3. Effect of this embodiment
4. Modified example, etc.

### 1. Photosensitive Glass

A photosensitive glass is not particularly limited, and for example there is a glass containing Au, Ag, and Cu as photosensitive components in SiO₂—Li₂O—Al₂O₃-based glass, and further containing therein CeO₂ as a sensitizing component, and more specifically, for example this is the composition containing SiO₂: 55 to 85 mass %, Al₂O₃: 2 to 20 mass %, Li₂O: 5 to 15 mass %, SiO₂, Al₂O₃ and Li₂O: 85 mass % or more in total based on an entire body of the photosensitive glass, and Au: 0.001 to 0.05 mass %, Ag: 0.001 to 0.5 mass %, Cu₂O: 0.001 to 1 mass % as photosensitive components, and further CeO₂: 0.001 to 0.2 mass % as sensitizing components. In this embodiment, PEG3 by HOYA Corporation will be described as the photosensitive glass.

An oxidation-reduction reaction occurs between the sensitizing agent and the photosensitive component by irradiating the photosensitive glass with UV-rays and holding the photosensitive glass in a temperate range of about 450 to 600° C., to thereby generate metal atmos. In this state, further heating is applied thereto to agglomerate the metal atoms and form a colloid, and the crystal of Li₂O—SiO₂ (lithium monosilicate) is precipitated and grown, with the colloid as a crystal nucleus.

Further, by holding the PEG3 in a temperature range of 800 to 900° C., Li₂O-2SiO₂ (lithium disilicate) crystal is precipitated in the photosensitive glass, to thereby obtain a crystallized photosensitive glass (PEG3C by HOYA Corporation).

Thus, the photosensitive glass is a glass that is easily crystallized, and a glass having a wide temperature range (crystallization temperature range) of generating crystallization. For example, the crystallization temperature range deriving from heating the photosensitive glass, is a range of 500 to 995° C.

Further, a glass transition temperature (Tg) of the PEG3 is 465° C., and a deformation point temperature (Ts) is 515° C. In addition, a liquid phase temperature showing a boundary between a temperature in a molten state and a temperature at which a crystal is started to precipitate, is 995° C.

### 2. Method of Manufacturing a Photosensitive Glass Molding

As described above, the photosensitive glass is easily crystallized, and the crystallization temperature range is wide. Accordingly, if such a photosensitive glass is molded by Reheat-Press, the crystal is easily precipitated. Particularly, in the Reheat-Press, in order to prevent a crack of the glass due to a heat shock, the photosensitive glass is molded by gradually heating it up to the vicinity of the deformation point temperature (Ts). When the photosensitive glass is heated up to the vicinity of Ts (515° C.) of the photosensitive glass, lithium disilicate is likely to be precipitated by relatively loosely heating, and lithium monosilicate is likely to be precipitated by more rapidly heating.

In addition, since the photosensitive glass is more hardly deformed than a normal glass during press-molding, it is significantly difficult to expand the photosensitive glass by Reheat-Press if such a crystal is precipitated. Also, if the lithium monosilicate is precipitated, not only a crystallized portion by exposure, but also the lithium monosilicate precipitated during heating is solved by etching when applying fine processing to the photosensitive glass. Therefore a depression, etc., is formed on an unexpected part.

Therefore, this embodiment employs a method different from the Reheat-Press, which is a method capable of easily expanding the photosensitive glass and not allowing the crystal such as lithium monosilicate to be present in the photosensitive glass (photosensitive glass molding) after molding. This method will be described hereafter in detail.

This method is the method of melting the crystal (lithium monosilicate or lithium disilicate) precipitated when passing through the crystallization temperature range of the photosensitive glass at not less than the liquid phase temperature of the photosensitive glass, and molding the photosensitive glass material in a state in which the crystal is not present, to thereby obtain the photosensitive glass molding having a large size expanded in a radial direction. This method is also referred to as a Re-Melting Press hereafter in this embodiment.

In the Re-Melting Press, first, the photosensitive glass material is prepared. The photosensitive glass material is not particularly limited, if is made of the abovementioned photosensitive glass. A rod-shape and a block shape, etc., are given for example as the shape of the photosensitive glass material. However, it is acceptable to employ any shape, if the photosensitive glass material has a shape expanded from an original shape in a radial direction and thinned in a thickness direction by being stretched by press molding.

### (Heating Step)

Subsequently, the photosensitive glass material is placed and heated on a holding member. The holding member is used for holding the photosensitive glass material softened by heating, and charging it into the press molding in the molding step described later.

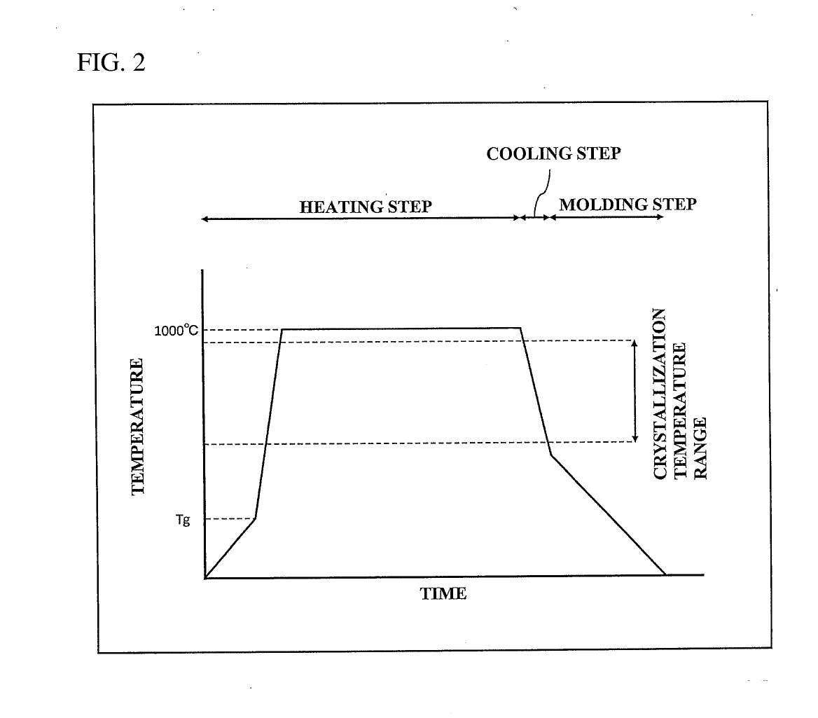

FIG. 2 shows a surface temperature profile of the photosensitive glass in a cooling step and a molding step described later. In this embodiment, first, the photosensitive glass is heated to the vicinity of Tg of the photosensitive glass, that is, to the vicinity of 465° C., and thereafter rapidly heated to 1000° C. which is higher than a liquid phase temperature (995° C.) of the photosensitive glass. As shown in FIG. 2, since a crystallization temperature range of the photosensitive glass is a range of 500 to 995° C., the photosensitive glass material may be rapidly heated so as to pass through this range quickly as much as possible.

Specifically, the photosensitive glass is preferably heated so that a heating rate in the crystallization temperature range is 200° C./min or more. Even in a case that the heating rate is set in the abovementioned range, the crystal of lithium monosilicate or lithium disilicate, etc., is precipitated, but its precipitation can be an amount that can be re-melted.

In the glass other than the photosensitive glass, there is a high possibility of being damaged due to a thermal shock, when the heating rate is set to be fast up to a lower limit value (200° C./min) of the abovementioned range. On the other hand, since the photosensitive glass is the glass having a relatively large thermal expansion coefficient, it is not damaged by the abovementioned lower limit value. However, even in a case of the photosensitive glass, there is a possibility of damage due to the thermal shock if the heating rate is excessively fast. Accordingly, an upper limit of the heating rate may be set to a rate of not damaging the photosensitive glass material.

In this embodiment, the photosensitive glass material heated up to Tg is charged into a furnace in which the temperature is maintained to 1000° C. which is higher than the liquid phase temperature. Thus, it is considered that the surface temperature of the photosensitive glass material reaches 1000° C. from the vicinity of Tg in about several minutes. That is, the heating rate is about 10000° C./h or higher. Further, since the photosensitive glass material is heated to a temperature higher than the liquid phase temperature, the photosensitive glass material is softened.

After the temperature of the photosensitive glass material reaches 1000° C., as shown in FIG. 2, the photosensitive glass material is held at 1000° C. By holding the photosensitive glass material at 1000° C., the crystal precipitated during heating can be re-melted. In FIG. 2, although the photosensitive glass material is held at a constant temperature (1000° C.), the temperature is not required to be constant if it is higher than the liquid phase temperature.

In this embodiment, in order to completely re-melt the crystal, the time for holding the photosensitive glass is determined according to a heat capacity of the photosensitive glass material. That is, when a weight of the photosensitive glass material is large, the time is prolonged, and when the weight is small, the time is shortened. Specifically, when the weight of the photosensitive glass material is about 1.4 kg, the time is set to be about 20 minutes.

Usually, it is conceivable that as the time is prolonged for holding the photosensitive glass material at the liquid phase temperature or higher, the re-melting of the precipitated crystal is advanced, but actually if the time is excessively long, the crystal is precipitated reversely. Accordingly, as described above, by determining the time according to the heat capacity of the photosensitive glass material, the time can be set so that the crystal is not precipitated.

If the time is excessively long, the crystal is precipitated in some cases. Although the reason is not clear, it is conceivable that when the crystal is exposed by a light emitted from a heater of a furnace, the crystal is precipitated in some cases, because an area showing a lower temperature than the liquid phase temperature exists locally in the photosensitive glass material.

When the photosensitive glass material passes through the crystallization temperature range, a part of the precipitated crystal is not re-melted and remained at any kind of the holding time, if a precipitation amount of the crystal is several % or more of the entire body because the heating rate is slow.

There is particularly no limit in selecting a material of the holding member so long as it can withstand the thermal shock due to rapid heating. In this embodiment, the holding member is charged into the furnace together with the photosensitive glass material heated to the vicinity of Tg, and rapidly heated up to the temperature higher than the liquid phase temperature. Therefore, the holding member is preferably made of diatomaceous earth or alumina fiber, etc.

Such a holding member is a member required for not allowing the softened photosensitive glass material to be flowed into the furnace.

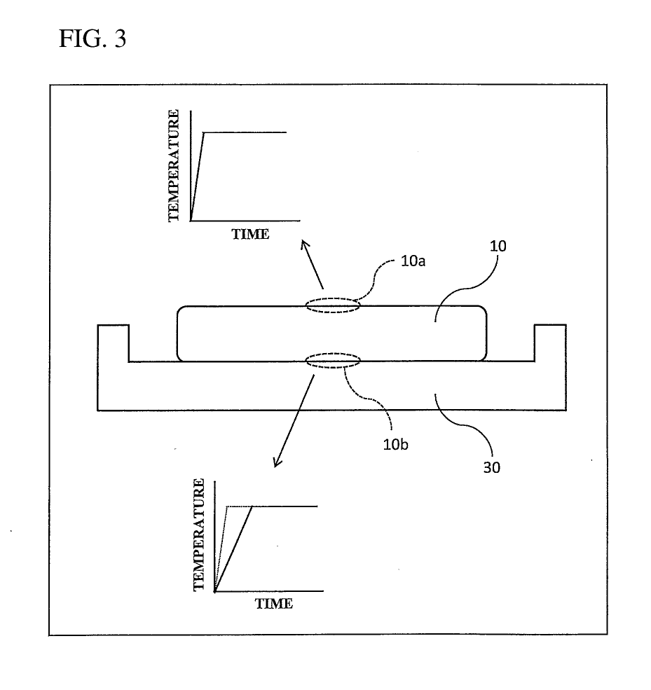

However, in the heating step, as shown in FIG. 3, regarding the photosensitive glass material 10 held by the holding member 30, the temperature profile during heating is different between a portion 10b in contact with the holding member 30, and a portion 10a not in contact with the holding member 30. That is, the heating rate of the portion 10b in contact with the holding member 30, is slower than the portion 10a not in contact with the holding member 30, and there is a difference in the heating rate. As a result, at the portion 10b in contact with the holding member 30, the time for passing through the crystallization range becomes long, and an amount of the precipitated crystal is more increased than an amount at the portion 10a not in contact with the holding member 30. Accordingly, the time for holding the photosensitive glass material 10 at higher than the liquid phase temperature, is determined in consideration of the amount of the crystal precipitated on the portion 10b in contact with the holding member 30.

The holding time in the heating step can be short, by heating the photosensitive glass material so as not to allow the difference to be generated in the heating rate as shown in FIG. 3. However, as described above, the holding member 30 is the member required for holding the photosensitive glass material 10.

### (Cooling Step)

After elapse of the holding time, the photosensitive glass material is taken out from the furnace, and cooled (cooling step). Similarly to the case of heating, the photosensitive glass material is preferably rapidly cooled, so as to pass through the crystallization temperature range of the photosensitive glass quickly as much as possible. Specifically, the photosensitive glass material is preferably rapidly cooled so that a cooling rate in the crystallization temperature range is 200° C./min or more.

In this embodiment, the photosensitive glass material is taken out from the furnace, and is exposed at a room temperature for a prescribed time, and cooled so that the temperature of the photosensitive glass material is about 700° C. In the cooling step, unlike the case of the heating, the photosensitive glass material and the holding member are rapidly cooled as a whole, and therefore almost no difference is generated in the temperature as shown in FIG. 3. Accordingly, the crystal is not precipitated in the cooling step.

### (Molding Step)

In this embodiment, the molding step is performed immediately after the cooing step, and in the molding step as well, the photosensitive glass material is cooled. Specifically, the photosensitive glass material taken out from the furnace and cooled down to about 700° C., is charged into a lower mold of the mold composed of an upper mold and a lower mold, and subjected to press molding. The lower mold is heated to 500 to 600° C., and the photosensitive glass material is cooled from 700° C. to the temperature of the lower mold, and stretched by press molding in the radial direction, and molded into a photosensitive glass molding with its size more expanded than the photosensitive glass material. The temperature of the lower mold is set to be higher than Tg (465° C.) of the photosensitive glass. Thus, the photosensitive glass material is easily stretched, and the photosensitive glass molding having a large size can be obtained.

When a size of a large photosensitive glass molding is 200 mm or more, although depending on the size of the photosensitive glass material, an effect of the present invention is remarkably exhibited, and when the size is 300 mm or more, the effect of the present invention is further remarkably exhibited. In the present invention, the size of the photosensitive glass molding shows a diameter when the photosensitive glass molding has a circular plate shape, and shows a length of a side when the photosensitive glass molding has a rectangular plate shape.

A pressure during press molding is not particularly limited, and may be determined according to a desired size. Further, the holding time during press molding is preferably set to about 3 to 7 minutes. If the holding time is excessively short, the photosensitive glass molding is likely to be bent after end of the press molding, and if the holding time is excessively long, there is a much internal distortion due to a stress, and therefore the photosensitive glass molding is likely to be broken.

Further, as the thickness of the photosensitive glass molding becomes large, the internal distortion (stress) accumulated in the cooling step and the press step, are likely to be increased. Accordingly, in order to prevent the breakage during press molding or in a post-process, the upper limit of the thickness of the photosensitive glass molding obtained by the press molding is preferably set to about 30 mm.

### (Distortion Removing Step)

As described above, since the internal distortion remains in the photosensitive glass molding, there is a possibility that a breakage, etc., due to the internal distortion (stress) occurs by processing, etc., in the post-process. Therefore, processing of removing the internal distortion (distortion removing step) is performed. Specifically, the photosensitive glass molding is charged into a heating furnace, etc., and heated to the vicinity of Tg (465° C.), and gradually cooled (annealed) from this temperature to a room temperature. The cooling rate during annealing can be suitably set, and preferably set to 1° C./h to 3° C./h. In this embodiment, the cooling rate is set to about 2° C./h. By annealing the photosensitive glass molding from the vicinity of Tg to the room temperature, the internal distortion of the photosensitive glass molding is removed.

### (Grinding Step)

An outer peripheral part is removed from the photosensitive glass molding whose internal distortion is removed, and further the photosensitive glass molding is sliced to obtain a plurality of wafers having a desired thickness. A surface of the sliced photosensitive glass molding is polished, to obtain a wafer. The obtained wafer is subjected to a prescribed fine processing, and is used for an interposer, a substrate for IPD, and a gas electron amplifying substrate, etc.

### 3. Effect of this Embodiment

According to this embodiment, by holding the photosensitive glass material at a temperature higher than the liquid phase temperature of the photosensitive glass, the precipitated crystal during heating can be re-melted. Therefore, the photosensitive glass material can be press-molded in a state that the crystal is not precipitated on the photosensitive glass material, and can be stretched up to a desired size. In order to press-mold the photosensitive glass material softened by heating up to the liquid phase temperature or higher, the size can be more easily expanded than a case of the Reheat-Press. In addition, since the crystal is not precipitated, even if etching is applied to a crystallized portion formed by exposing the photosensitive glass during fine processing such as formation of the through holes, a portion other than the crystallized portion is removed by etching, and a depression is not formed.

It is difficult to completely re-melt the crystal precipitated during heating, if the precipitation amount is several % or more of the entire body. Therefore, in order to suppress the precipitation amount of the crystal in a re-melting range, the heating rate is set to the abovementioned rate. Even in a case of such a significantly fast heating rate, the photosensitive glass material having a relatively high thermal expansion coefficient, is not broken by a thermal shock, and therefore the press-molding can be performed in the post-process.

Further, in the heating step, even if the time for holding the photosensitive glass material at the liquid phase temperature or higher is excessively long, the crystal is precipitated reversely. Therefore, the holding time is preferably determined according to the heat capacity of the photosensitive glass material.

Further, after elapse of the holding time in the heating step, the photosensitive glass material is cooled, which is softened by heating to the liquid phase temperature or higher. Thereafter, by performing the press-molding using a mold held at a temperature higher than Tg of the photosensitive glass, the photosensitive glass molding whose size is expanded, can be obtained.

### 4. Modified Example, Etc.

In the abovementioned embodiment, other photosensitive glass may be used as the photosensitive glass, as explained using PEG3 for example. In this case as well, by applying re-melting press to the photosensitive glass in consideration of the glass transition temperature (Tg), the deformation point temperature (Ts), and the liquid phase temperature, etc., the plate-like photosensitive glass molding having a desired large size can be obtained without precipitating the crystal in the photosensitive glass.

As described above, the embodiments of the present invention have been described. However, the present invention is not limited to the abovementioned embodiments, and can be variously modified in a range not departing from the gist of the present invention.

### Example

The present invention will be described hereafter based on further detailed examples, but the present invention is not limited thereto.

### Example

A block-shaped glass material cutout from an ingot glass of PEG3 by HOYA Corporation, was used as the photosensitive glass material. This glass material had a dimension of 200 mm×200 mm×35 mm. PEG3 is the photosensitive glass having a composition of SiO₂—Li₂O—Al₂O₃, and having the glass transition temperature (Tg) of 465° C., the deformation point temperature (Ts) of 515° C., and the liquid phase temperature of 995° C.

This photosensitive glass material was placed on the holding member made of a diatomaceous earth, and heated up to Tg. Subsequently, the photosensitive glass material heated to Tg was charged into the heating furnace whose temperature was maintained to 1000° C., together with the holding member.

When the surface temperature of the photosensitive glass material charged into the heating furnace was measured using a laser thermometer, the surface temperature reached 1000° C. in about 1 minute after charging into the heating furnace. In this example, the photosensitive glass material was held for 20 minutes, after the surface temperature of the photosensitive glass material reached 1000° C.

After the photosensitive glass material was held for 20 minutes at 1000° C., the softened photosensitive glass material was taken out from the heating furnace, and allowed to stand for 30 seconds at a room temperature, and cooled down to about 700° C. Subsequently, the photosensitive glass material cooled down to about 700° C. was charged into a lower mold heated to 500° C., and pressed by the upper mold, to thereby perform press molding to the photosensitive glass material. The press time was set to 3 to 7 minutes.

The photosensitive glass material (photosensitive glass molding) after press molding had a size of 320 mm×320 mm×20 mm. Further, when a cross-sectional surface of this photosensitive glass was visually observed, the cross-sectional surface was transparent, and it was confirmed that the crystal was not precipitated.

An outer peripheral part of the obtained photosensitive glass molding was removed, and further sliced into a thin plate shape by a wire saw. The surface of the sliced photosensitive glass molding was polished, to obtain a wafer. The wafer had a size of 300 mm×300 mm×0.9 mm.

Fine processing of forming the through holes, was applied to the obtained wafer. A diameter of each through hole was 170 μm, and an arrangement pitch of the through holes was 280 μm, and a total number of the through holes was 1154423. First, although a crystallized portion (latent image) was formed on the wafer by exposure by UV-rays, sensitivity to the UV-rays was not deteriorated, and an excellent latent image could be formed. Subsequently, the latent image was solved by performing etching by hydrofluoric acid to form the through holes. Wherein, etching fault did not occur, and the through holes could be formed satisfactorily, and the formation of depressions, etc., at a portion other than the through holes could not be found.

### DESCRIPTION OF SIGNS AND NUMERALS

10 Photosensitive glass substrate
11 Crystal precipitated by heating
12 Crystallized portion
13 Through hole
14 Depression
30 Holding member

1. A method of manufacturing a photosensitive glass molding, comprising:
softening a solid-state photosensitive glass material by heating; and
molding the softened photosensitive glass material to obtain a photosensitive glass molding,
wherein in the heating, a crystal precipitated on the photosensitive glass material by heating, is melted.

2. The method of manufacturing a photosensitive glass molding according to claim 1, wherein in the heating, the photosensitive glass material is heated up to not less than a liquid phase temperature of a photosensitive glass, and by holding the photosensitive glass material at this temperature, the crystal is melted.

3. The method of manufacturing a photosensitive glass molding according to claim 2, wherein a holding time of the photosensitive glass at the temperature not less than the liquid phase temperature of the photosensitive glass, is determined according to a heat capacity of the photosensitive glass.

4. The method of manufacturing a photosensitive glass molding according to claim 1, wherein a heating rate in a crystallization temperature range of the photosensitive glass is 200° C./min or more in the heating.

5. The method of manufacturing a photosensitive glass molding according to claim 1, wherein the method further comprises cooling the photosensitive glass material after melting the crystal, and a cooling rate in the crystallization temperature range of the photosensitive glass is 200° C./min or more in the cooling.

6. The method of manufacturing a photosensitive glass molding according to claim 1, wherein the method further comprises removing a distortion accumulated in the photosensitive glass molding.

7. The method of manufacturing a photosensitive glass molding according to claim 1, wherein the photosensitive glass is heated in the heating, using a holding member for holding the photosensitive glass material.

8. A photosensitive glass molding manufactured by the method of manufacturing a photosensitive glass molding according to claim 1.
